(19) United States
(12) Patent Application Publication
(10) Pub. No.: US 2026/0336586 A1
(43) Pub. Date: Oct. 29, 2026

(54) ELECTROPNEUMATIC PARKING BRAKE DEVICE WITH PARALLEL VENTING PATHS

(71) Applicant: ZF CV Systems Global GmbH, Bern (CH)

(72) Inventors: Arne Michaelsen, Seelze (DE); Robert Otremba, Ronnenberg (DE); Julian Van Thiel, Grossburgwedel (DE)

(21) Appl. No.: 19/702,947

(22) Filed: Jun. 9, 2026

Related U.S. Application Data
(63) Continuation of application No. PCT/EP2024/083572, filed on Nov. 26, 2024.

(30) Foreign Application Priority Data
Dec. 22, 2023 (DE) 10 2023 136 453.7

(51) Int. Cl. B60T 13/38; B60T 8/172; B60T 13/58; B60T 13/68; B60T 17/22

(52) U.S. Cl. CPC B60T 13/385; B60T 8/172; B60T 13/588; B60T 13/683; B60T 17/22; B60T 2270/402; B60T 2270/406; B60T 2270/413

(57) ABSTRACT

A parking brake device is for pressurizing and venting spring brake cylinders and includes a parking brake valve unit and a parking brake redundancy unit configured to connect a parking compressed air path to a vent independently of the parking brake valve unit in order to vent at least one spring brake cylinder. The parking brake redundancy unit includes a first venting path and a parallel second venting path for venting a pressure of the parking compressed air path directly into the environment. A first redundancy valve unit is arranged in the first venting path and can be controlled by a first control unit. A second redundancy valve unit is arranged in the second venting path and can be controlled by a second control unit, which is independent of the first control unit. A brake system includes the parking brake device. A vehicle includes the brake system.

### CROSS-REFERENCE TO RELATED APPLICATIONS

This application is a continuation application of international patent application PCT/EP2024/083572, filed Nov. 26, 2024, designating the United States and claiming priority from German application 10 2023 136 453.7, filed Dec. 22, 2023, and the entire content of both applications is incorporated herein by reference.

### TECHNICAL FIELD

The disclosure relates to an electropneumatic parking brake device for pressurizing and venting one or more spring brake cylinders of an at least partially electronically controllable pneumatic brake system for a vehicle, including an electropneumatic parking brake valve unit having a reservoir connection for receiving reservoir pressure from a compressed air reservoir, and a parking brake control unit, wherein the parking brake valve unit is configured to output a parking pressure at least at one spring accumulator connection in accordance with a parking brake signal. The disclosure further relates to an electronically controllable pneumatic brake system and a vehicle including such a brake system.

### BACKGROUND

Modern commercial vehicles commonly have an electronically controllable pneumatic brake system. The brake system generally includes spring brakes as parking brakes, also referred to as immobilizing brakes. The parking brakes operate under the action of spring force, can be released by pressurization of spring brake cylinders with a parking pressure, and can be applied by venting. Valves within a service brake system are electronically controlled in order to control a service brake pressure. The valves may be provided in, or outside, so-called axle modulators. The axle modulators may be automated or partially automated, and/or may be electronically controllable by an autonomous unit. The parking brakes are also electronically actuated. For example, the pressurization or venting of the spring brake cylinders can be controlled by actuation of a solenoid valve. The spring brake cylinders may be combined with service brake cylinders, such that the spring brake and service brake act on the same brake pistons. Suitable configuration measures may be implemented in order to avoid mechanical overloading of the brake pistons as a result of summation of braking forces from the service brakes and the spring brakes. If the service brakes are operated while the parking brakes are active, the spring brake cylinders are simultaneously pressurized in order to thus avoid summation of the braking forces. Such a function is also referred to as an "anti-compound function".

It must be possible for the parking brake to be applied by a driver of the vehicle. In some markets, this is performed by way of an electronic parking brake demand to the parking brake device. In other markets, for safety reasons, the spring brake cylinders are vented if the reservoir pressure in the service brake system falls. Here, the service brake and parking brake may also be assigned to different brake circuits.

Safety concepts are of high relevance in electropneumatic brake systems for modern vehicles. In particular in vehicles with automated or partially automated driving functions, braking functions must remain available at least to a restricted degree even in the event of a fault or an electrical failure of a control unit. Only in this way can the safety of the vehicle, its occupants and other road users be ensured. For this purpose, it is known to provide redundancy levels that can continue to provide an at least restricted braking function even in the event of failure of a primary system.

Aside from the service brakes, a redundancy level is also desired for the parking brake because in most cases vehicles can be safely parked only with the parking brake applied. To enhance functionality, and in particular to be able to pressurize and thus release the corresponding spring brake cylinders of the parking brake irrespective of the occurrence of a fault in any of the various levels, be it the service level or a redundancy level of the brake system, it is desirable for the spring brake cylinders to be capable of being controlled via two independent paths. This is intended to increase the range of functions and the operational readiness of the vehicle. Through the provision of a redundancy level, it is thus possible to ensure that the vehicle can be safely parked even in the event of one or more faults in the brake system.

DE 10 2021 122 497 A1 has disclosed a method for operating an electropneumatic brake system for a vehicle, wherein the brake system includes a service brake system and a parking brake system, wherein the parking brake system includes at least one spring brake cylinder. The method is characterized by the steps: providing, via a control unit, a control signal for maintaining a spring accumulator pressurization pressure with which the at least one spring brake cylinder is pressurized; stopping the provision of the control signal in the event of a fault and/or an electrical failure and/or in a diagnostic situation of the control unit; thus automatically ending the maintaining of the spring accumulator pressurization pressure in order to vent the at least one spring brake cylinder; thus triggering a spring accumulator failure braking operation of the vehicle via the parking brake system, with the spring accumulator pressurization pressure being vented by way of a service brake venting function of the service brake system. The service brake venting function makes it possible to realize at least one, in particular continuously or intermittently opened, venting path in the service brake system for the purposes of venting the at least one spring brake cylinder. The service brake venting function is implemented in particular via a valve in the service brake system, preferably an outlet valve and/or a further outlet valve.

Further partially redundant systems are known from DE 10 2022 101 142 A1, DE 10 2021 122 498 A1, DE 10 2021 122 499 A1, DE 10 2020 132 875 A1 and EP 3 145 769 B1.

Even though some redundant options for applying or releasing a parking brake have already been provided by known systems, there is a need for further improvements. In particular, in the case of the aforementioned known options, the outlay on assembly and production can be high, because the connection to the service brake system can require long line paths. Furthermore, the achievable system dynamics can be restricted.

It is therefore desirable to improve the application of a parking brake. In particular, the venting of at least one spring brake cylinder in a reliable manner and with low effort is to be made possible.

### SUMMARY

It is an object of the disclosure to specify an improved electropneumatic parking brake system which enables a spring brake cylinder to be vented in a simple and/or reliable manner even in the case of redundancy.

In a first aspect, the disclosure achieves this object with an electropneumatic parking brake device according to the disclosure. Starting from an electropneumatic parking brake device of the type mentioned at the outset, an electropneumatic parking brake redundancy unit is further provided, which is configured to connect a parking compressed air path to a vent independently of the electropneumatic parking brake valve unit in order to vent at least one spring brake cylinder, wherein the parking brake redundancy unit includes at least one first main connection for receiving a pressure of the parking compressed air path, a first venting path for venting the pressure directly into the environment, and a second venting path for venting the pressure directly into the environment. A first electropneumatic redundancy valve unit of the electropneumatic parking brake redundancy unit is arranged in the first venting path and can be controlled by a first control unit. A second electropneumatic redundancy valve unit of the electropneumatic parking brake redundancy unit is arranged in the second venting path and can be controlled by a second control unit. The second control unit is independent of the first control unit. The first venting path and the second venting path are mutually parallel venting paths for venting the received pressure of the parking compressed air path directly into the environment.

As a rule, the electropneumatic parking brake valve unit is configured for pressurizing and venting spring brake cylinders. According to the disclosure, the parking brake redundancy unit is also provided for venting a spring brake cylinder of the brake system and thus applying the parking brake. For this purpose, the parking brake valve unit can connect a parking compressed air path to a vent, wherein this connection can be made independently of the electropneumatic parking brake valve unit. This means that a spring brake cylinder can be vented even if the electropneumatic parking brake valve unit has a fault, is not supplied with power or is otherwise restricted in its functioning. The parking compressed air path is a compressed air path assigned to the vehicle parking brake. This can be a compressed air path which is directly connected to one or more spring brake cylinders. For example, the parking compressed air path can be a compressed air path between the spring accumulator connection of the parking brake valve unit and the spring accumulator of the spring brake cylinder. However, it may for example and preferably also be provided that the parking compressed air path is a supply path which connects a compressed air reservoir of the brake system to the parking brake and/or which is provided for supplying a service brake circuit.

The parking brake redundancy unit includes at least one first venting path and one second venting path. The first venting path connects a main connection of the parking brake redundancy unit to a first redundancy vent into the environment. The second venting path connects a main connection to a second redundancy vent. The first redundancy vent and the second redundancy vent flow directly into the environment. There are therefore no other functional units of a brake system between the respective redundancy vent and the environment. However, it may be provided that the first and/or second redundancy vent includes one or more passive elements, such as a muffler and/or a line. In particular, no switchable components or modulators are arranged between the redundancy vent and the environment. The direct connection of the redundancy vent to the environment eliminates further sources of faults. In addition, a highly dynamic system can be achieved. In addition, line lengths can be reduced, thereby making it possible to reduce the assembly and production outlay on the parking brake device. The main connection of the second venting path can be the main connection to which the first venting path is also connected. The second redundancy vent of the second venting path is preferably different from the first redundancy vent of the first venting path. However, the first redundancy vent and the second redundancy vent can also be formed by a common redundancy vent. In this case, the parallel venting paths then flow into the same redundancy vent. However, it should be understood that the first venting path and the second venting path can in principle also be connected to more than two main connections and/or redundancy vents.

The first venting path and the second venting path are preferably parallel to a primary venting path of the parking brake valve unit. The primary venting path connects the spring accumulator connection of the parking brake valve unit to a primary vent of the parking brake valve unit. The first venting path of the parking brake redundancy unit, the second venting path of the parking brake redundancy unit, and the primary venting path of the parking brake valve unit are preferably connected to one another at the spring accumulator connection. However, it may also be provided in a possible alternative that the first venting path, the second venting path and the primary venting path lead into a connecting line to the spring brake cylinder. In other variants, the first venting path, the second venting path, and/or the primary venting path are completely separate.

The first electropneumatic redundancy valve unit can be controlled by a first control unit and the second electropneumatic redundancy valve unit can be controlled by a second control unit. The control units can be control units of the parking brake device, but they do not have to be. The first control unit and/or the second control unit are/is a service brake control unit of a brake system. The second control unit is independent of the first control unit. It is thereby possible to further increase the fail safety of the parking brake device since, in the event of a failure of one of the control units, the other control unit can continue to function.

In a first further embodiment of the electropneumatic parking brake device, the first redundancy valve unit has a first electrically switchable venting valve, which is arranged in the first venting path and is configured to interrupt the first venting path in a de-energized state, and the second redundancy valve unit has a second electrically switchable venting valve, which is arranged in the second venting path and is configured to interrupt the second venting path in a de-energized state. The first electrically switchable venting valve is preferably pre-loaded into a closed state and returns to it when it is de-energized. Similarly, the second electrically switchable venting valve is preferably also preloaded into a closed state. By energizing or supplying it with electrical energy, the first control unit can switch the first venting valve to an open state, in which the first venting valve opens the first venting path. Similarly, the second venting valve can be controlled by the second control unit and can be energized or supplied with electrical energy by the unit. By such control, the second venting valve can be moved to an open state, in which it opens the second venting path. Providing two parallel venting paths means that the main connection and a parking compressed air path connected thereto can still be vented, even if one of the two control units has a fault and accordingly the first venting valve or the second venting valve can no longer be switched to the open state.

The first redundancy valve unit preferably has a third electrically switchable venting valve, which is arranged in the second venting path. Alternatively or in addition, the second redundancy valve unit preferably includes a fourth electrically switchable venting valve, which is arranged in the first venting path. In a particularly preferred embodiment, the first redundancy valve unit and the second redundancy valve unit therefore each include at least one venting valve in the first venting path and in the second venting path. This allows each of the control units to interact with both venting paths. This may further increase operational safety.

The third venting valve is preferably open in a de-energized state and/or the fourth venting valve is open in a de-energized state. In the open state, the third venting valve opens the second venting path. Similarly, the fourth venting valve opens the first venting path in a de-energized state. This can prevent the third venting valve from blocking the second venting path in the event of a fault in the first control unit. The main connection can then also be vented via the second venting path even in the event of a failure of the first control unit. The same applies mutatis mutandis to the fourth venting valve and the first venting path.

The third venting valve can be controlled by the first control unit. The first control unit can switch the third venting valve to a closed state and thus block the second venting path. Similarly, the second control unit can switch the fourth venting valve to a closed state and block the first venting path. In particular, this allows for increased safety in the event that one of the control units has a fault and accidentally opens the associated compressed air path. For example, the first control unit can switch the third venting valve to the closed state if the second control unit has a fault and switches the second venting valve to an open state, even though this is not desired in the current driving situation. In this way, it is possible to further enhance operational safety.

According to various embodiments, the electropneumatic parking brake device includes a first pressure sensor for detecting a first pressure of the first venting path, wherein the first pressure sensor is configured to provide the first control unit with first pressure signals corresponding to the detected first pressure. Alternatively or in addition, the electropneumatic parking brake device can also include a second pressure sensor for detecting a second pressure of the second venting path, wherein the second pressure sensor is configured to provide the second control unit with second pressure signals corresponding to the detected second pressure. As a particular preference, the electropneumatic parking brake device includes the first pressure sensor and the second pressure sensor.

According to various embodiments, the first pressure sensor is arranged upstream of the first venting valve. Based on the first pressure signals, the first control unit can in this way determine whether or not there is a pressure, such as a parking pressure, to be vented at the inlet of the first venting valve. Similarly, the second pressure sensor can be arranged upstream of the second venting valve. It should be understood that the arrangement of the valves and pressure sensors refers to their functional arrangement. A pressure sensor arranged upstream of a valve is configured to detect a pressure upstream of this valve, but may also be arranged physically remote from it. For example, the first pressure sensor can be connected by a measurement line to a segment of the first venting path upstream of the first venting valve. As a particular preference, the first pressure sensor is arranged between the first venting valve and the fourth venting valve. The fourth venting valve is preferably arranged upstream of the first venting valve, that is, closer to the main connection. The second pressure sensor is preferably arranged between the second venting valve and the third venting valve.

The electropneumatic parking brake device preferably includes at least one connection pressure sensor for detecting a pressure applied to the main connection. The connection pressure sensor is preferably configured to provide a control unit with connection pressure signals corresponding to the pressure applied to the main connection. The connection pressure sensor can preferably be connected to the first control unit and/or the second control unit. A control unit connected to the connection pressure sensor can, for example, determine, using the connection pressure signals, whether or not a spring accumulator pressure is present at the main connection, or whether a spring brake cylinder connected to the main connection via the parking compressed air path is pressurized or vented. In further embodiments, a plurality of connection pressure sensors may also be provided.

The first electrically switchable venting valve and the second electrically switchable venting valve are preferably 2/2-way valves, in particular solenoid valves.

In a second aspect, the disclosure achieves the object mentioned at the outset via an electronically controllable pneumatic brake system for a vehicle including at least one first front axle brake actuator and one second front axle brake actuator for a front axle of the vehicle and at least one first rear axle brake actuator and one second rear axle brake actuator for a rear axle of the vehicle. The brake system further includes a primary system including a primary control unit at least for controlling the first front axle brake actuator and the second front axle brake actuator and/or for controlling the first rear axle brake actuator and the second rear axle brake actuator, and an electropneumatic parking brake device according to one of the preferred embodiments described above in accordance with the first aspect of the disclosure. The at least one spring accumulator connection of the electropneumatic parking brake valve unit is preferably connected to at least one first spring brake cylinder. The primary system is preferably a service brake system of the vehicle. The primary control unit is typically independent of the parking brake control unit. The electropneumatic parking brake valve unit of the parking brake device is configured to pressurize a parking brake cylinder connected to the spring accumulator connection (releasing the parking brake). Furthermore, the parking brake valve unit is preferably configured to vent the parking brake cylinder connected to the spring accumulator connection. This is preferably done by corresponding signals from the parking brake control unit. The parking brake valve unit thus typically serves as the primary device for applying and releasing the parking brake of the vehicle. The parking brake redundancy unit preferably provides redundancy for the parking brake valve unit and allows the parking brake to be applied even if the parking brake valve unit, in particular the parking brake control unit, has a fault. However, it should be understood that the main connection of the parking brake redundancy unit does not need to be connected to the spring brake cylinder to achieve this.

In a first embodiment of the brake system, however, at least the first spring brake cylinder is connected to the main connection of the parking brake redundancy unit. The parking brake redundancy unit is preferably switchable to connect the spring brake cylinder to the environment via the first venting path, via the second venting path or via the first venting path and the second venting path in order to vent the spring brake cylinder. In this case, the parking compressed air path is thus a compressed air path connected to at least one spring brake cylinder. When venting via the first venting path and the second venting path, a particularly large overall flow cross-section can be used to vent the compressed air path, and the parking brake can be applied particularly quickly.

In an alternative embodiment of the electronically controllable pneumatic brake system, the main connection is connected at least to a first compressed air reservoir of the brake system. The parking brake redundancy unit is switchable in order to connect the compressed air reservoir to the environment via the first venting path, the second venting path, or via the first venting path and the second venting path, in order to vent at least the first compressed air reservoir. In this variant, the parking compressed air path is thus a compressed air path connected to a first compressed air reservoir. The parking brake redundancy unit can connect the compressed air reservoir to the redundancy vent, causing a pressure drop in a supply air path. This can then cause the parking brake to be applied. In brake systems for the North American market, for example, a "push-pull valve" can typically be provided, which automatically applies the parking brake as soon as a supply pressure or reservoir pressure falls below a predefined pressure level. Here too, in this variant, highly dynamic performance can be achieved by using both venting paths for venting.

According to various embodiments, the primary control unit is or includes the first control unit. The primary control unit can then control the first electropneumatic redundancy valve unit. Since the primary control unit and the parking brake control unit are typically independent units, the primary control unit can thus form a redundancy level for the parking brake control unit. It is particularly advantageous here that an existing control unit can be used as a redundancy level. However, the first control unit may also be a separate control unit.

In a further embodiment of the embodiments described above, the electronically controllable pneumatic brake system further includes a secondary system having a secondary control unit, wherein the secondary system is configured to control the first front axle brake actuator and the second front axle brake actuator and/or to control the first rear axle brake actuator and the second rear axle brake actuator. The secondary system is preferably configured to control the first front axle brake actuator and the second front axle brake actuator and/or to control the first rear axle brake actuator and the second rear axle brake actuator if a fault is detected in the primary system. The secondary system then preferably forms a redundancy level for the primary system, the redundancy level being provided in particular in vehicles with high levels of automation. It is therefore also possible in particular for the secondary system to be a redundancy service brake system.

According to various embodiments, the secondary control unit is or includes the second control unit. In this preferred variant too, an existing control unit can then be used as redundancy for the parking brake control unit.

According to various embodiments, the electronically controllable pneumatic brake system preferably has a first voltage source and a second voltage source, wherein the first voltage source is provided for supplying electrical voltage to the first control unit, and wherein the second voltage source is provided for supplying electrical voltage to the second control unit. The provision of mutually independent voltage sources can further increase the fail safety of the brake system because failure of a single voltage source does not result in a total failure of the parking brake system. The parking brake control unit can be connected to the first voltage source or to the second voltage source to supply electrical voltage.

According to a third aspect of the disclosure, the object mentioned at the outset is achieved by a commercial vehicle having at least one front axle, at least one first rear axle and an electronically controllable pneumatic brake system according to any one of the above-described preferred embodiments of an electronically controllable pneumatic brake system in accordance with the second aspect of the disclosure.

It should be understood that the electronically controllable pneumatic brake system according to the second aspect of the disclosure and the commercial vehicle according to the third aspect of the disclosure have identical and similar sub-aspects.

### BRIEF DESCRIPTION OF DRAWINGS

The invention will now be described with reference to the drawings wherein:

FIG. 1 shows a schematic illustration of a commercial vehicle having an electronically controllable pneumatic brake system;

FIG. 2 shows a schematic illustration of a first embodiment of a parking brake device; and,

FIG. 3 shows a schematic illustration of a second embodiment of a parking brake device.

### DETAILED DESCRIPTION

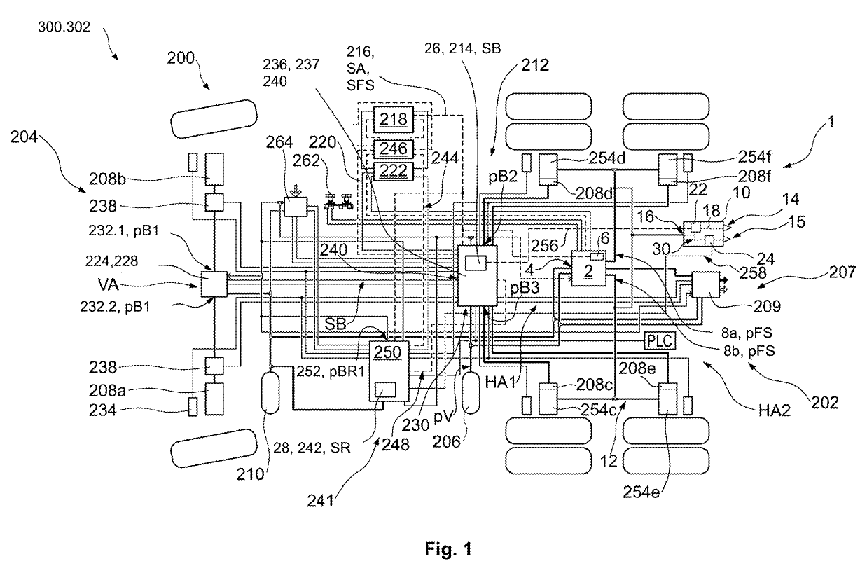

FIG. 1 shows an electronically controllable pneumatic brake system 200 having an electropneumatic parking brake device 1. In the present case, the electronically controllable pneumatic brake system 200 is used in a vehicle 300 configured as a commercial vehicle 302, which is illustrated here in highly schematic form, in particular with a front axle VA, a first rear axle HA1 and a second rear axle HA2.

Here, the electronically controllable pneumatic brake system 200 has a first, second, third, fourth, fifth and sixth service brake actuator 208a-208f for in each case one wheel of the vehicle 300. To supply the first to sixth service brake actuators 208a-208f with brake pressures, a rear axle brake circuit 202 and a front axle brake circuit 204 are provided. The service brake actuators 208a, 208b are assigned to the front axle VA and are therefore also referred to as front axle brake actuators 208a, 208b. Similarly, the service brake actuators 208c-208f assigned to the rear axles HA1, HA2 are also referred to as rear axle brake actuators 208c-208f. The rear axle brake circuit 202 is supplied by a first compressed air reservoir 206 and the front axle brake circuit 204 by a second compressed air reservoir 210. Here, the commercial vehicle 300 is configured as a towing vehicle and includes a trailer brake circuit 207 with a trailer module 209, which is provided for supplying a trailer connected to the commercial vehicle 300 (not shown) with compressed air.

The electronically controllable pneumatic brake system 200 has a service level and a first redundancy level. In the service level, the electronically controllable pneumatic brake system 200 includes a primary system 212 having an electronic primary control unit 214 that controls the electronically controllable pneumatic brake system 200 in the service level. The electronic primary control unit 214 is connected via a vehicle BUS 216 to an autonomous driving unit 218 and receives braking demand signals SA from this. Furthermore, the electronic primary control unit 214 is connected via a first supply line 220 to a first voltage source 222 and is supplied with electrical voltage therefrom. The electronic primary control unit 214 converts the braking demand signals SA and, based on this, outputs service brake signals SB at a first service axle modulator 224. Here, the first service axle modulator 224 is a front axle modulator 228 intended for the front axle VA. Alternatively or in addition, braking demand signals SA can also be provided by an electronic foot brake pedal 264 on the primary control unit 214.

The first service axle modulator 224 is connected to the second compressed air reservoir 210 and receives reservoir pressure pV therefrom. On the basis of the received service brake signals SB, the first service axle modulator 224 modulates a first service brake pressure pB1 at a first service brake pressure connection 232.1 and a second service brake connection 232.2. The first service brake pressure pB1 is preferably modulated on a wheel-specific basis at the first and second service brake pressure connections 232.1, 232.2, and the first service axle modulator 224 is configured as a two-channel modulator. In other embodiments, the first service brake pressure connection 232.1 and the second service brake pressure connection 232.2 may however also be combined, and the first service axle modulator 224 may thus be configured as a single-channel axle modulator, which modulates the first service brake pressure pB1 on an axle-specific basis.

On the front axle VA, a first wheel speed sensor 234 is also provided, which provides first wheel speed signals SD at the primary control unit 214. The primary control unit 214 is configured to process the first wheel speed signals SD and to provide ABS switching signals to ABS valves 238 of the front axle VA in order in this way to achieve slip control or ABS modulation of the first service brake pressure pB1 and to avoid locking up of front wheels of the vehicle 300.

In the service level, the electronically controllable pneumatic brake system 200 further includes a second service axle modulator 236, which is provided for the first and the second rear axle HA1, HA2 and can thus also be referred to as a rear axle modulator 237. In the embodiment shown in FIG. 1, the rear axle modulator 237 is installed with the electronic primary control unit 214 to a module, which is referred to here as central module 240. However, it should be understood that the rear axle modulator 237 and the primary control unit 214 can also be separate or structurally separate. The primary control unit 214 and the rear axle modulator 237 can then be connected to one another, for example, via a signal line or a BUS line. Internally, the electronic primary control unit 214 controls the rear axle modulator 237 in accordance with the braking demand signals SA received by the primary control unit 214 from the autonomous driving unit 218.

A reservoir connection 230 of the second service axle modulator 236 is connected to the first compressed air reservoir 206 and receives reservoir pressure pV therefrom. In accordance with its control by the primary control unit 214, the rear axle modulator 237 modulates at least a second service brake pressure pB2, but in the embodiment shown here, it also modulates a third service brake pressure pB3. In the embodiment shown in FIG. 1, the second service brake pressure pB2 is provided for the right side of the vehicle and the third service brake pressure pB3 is provided for the left side of the vehicle. Here, therefore, the rear axle modulator 237 is configured as a two-channel axle modulator. The second service brake pressure pB2 is intended for a fourth and sixth service brake actuator 208d, 208f, while the third service brake pressure pB3 is provided for a third and a fifth service brake actuator 208c, 208e. However, in other variants, the first service axle modulator 236 can also be configured as a single-channel modulator or as a multi-channel modulator with more than two outputs.

In the redundancy level, the electronically controllable pneumatic brake system 200 includes a secondary control unit 242 of a secondary system 241, which is provided for controlling the electronically controllable pneumatic brake system 200 in the event that the service level has one or more faults. The secondary control unit 242 can thus control the electronically controllable pneumatic brake system 200, for example, in the event of an electrical failure in the first voltage source 222, an electronic fault in the primary control unit 214, or the like.

Via the vehicle BUS 216, the electronic secondary control unit 242 is likewise connected to the autonomous driving unit 218, and from this likewise receives braking demand signals SA. In contrast to the primary control unit 214, the secondary control unit 242 is connected via a second supply line 244 to a second voltage source 246 and is supplied with electrical energy therefrom. The first and the second voltage sources 222, 246 are independent of one another, such that a failure in the first voltage source 222 does not lead to a loss of the second voltage source 246, and vice versa. The electronic primary control unit 214 and the electronic secondary control unit 242 are thus electrically independent of one another.

To be able to exchange signals, the primary control unit 214 and the secondary control unit 242 are connected to one another via a redundancy BUS 248. In this way, the secondary control unit 242 can determine the availability of the primary control unit 214, and perform the control of the electronically controllable pneumatic brake system 200 only if the primary control unit 214 is not available or no longer properly available. In variants, however, communication between the primary control unit 214 and the secondary control unit 242 may for example also take place via the vehicle BUS 216.

In the redundancy level, a redundancy axle modulator 250 is provided, which is connected to the secondary control unit 242 and receives redundancy braking signals SR therefrom. In the embodiment according to FIG. 1, the secondary control unit 242 is integrated into the redundancy axle modulator 250. In other variants, however, the secondary control unit 242 and the redundancy axle modulator 250 may also be physically separate units.

The redundancy axle modulator 250 is connected to the second compressed air reservoir 210, which is independent of the first compressed air reservoir 206, such that the second compressed air reservoir 210 can provide reservoir pressure pV even if the first compressed air reservoir 206 has failed. In other embodiments, the redundancy axle modulator 250 can also be connected to the second compressed air reservoir 210 or to the first compressed air reservoir 206 and the second compressed air reservoir 210.

The redundancy axle modulator 250 modulates a redundancy brake pressure pBR1 at a redundancy brake pressure connection 252 in accordance with the redundancy brake signals SR. The redundancy brake pressure pBR1 output at the redundancy brake pressure connection 252 is provided to the front axle modulator 228. The redundancy axle modulator 250 is shown in FIG. 1 as a single-channel axle modulator with only one redundancy brake pressure connection 252, but may also be configured as a multi-channel axle modulator, which can, for example, implement side-appropriate control of redundancy brake pressures.

The secondary control unit 242 can control the redundancy axle modulator 250 in such a way that, in the event of a fault of the primary control unit 214, a brake pressure, namely the redundancy brake pressure pBR1, is nevertheless provided at the front axle brake actuators 208a, 208b. As a departure from what is shown in FIG. 1, the redundancy level can also be provided for braking the first and second rear axles HA1, HA2. This can be implemented via the redundancy axle modulator 250 or via a second redundancy axle modulator. The secondary control unit 242 can then preferably also be provided for controlling such a second redundancy axle modulator.

The brake actuators assigned to the wheels of the rear axles HA1, HA2 are configured here as double-acting brake actuators, also referred to as Tristop cylinders. Aside from the service brake actuators 208c-208f, the brake actuators each also include a spring brake cylinder 254c-254f. The spring brake cylinders 254c-254f are configured to apply the brakes of the vehicle 300 when unpressurized or vented. The spring brake cylinders 254c-254f can thus advantageously be utilized as parking brakes, which do not have to be supplied with compressed air in order to brake the rear axles HA1, HA2. To release the rear wheels, the spring brake cylinders 254c-254f must be pressurized with a parking pressure pFS. This parking pressure pFS acts counter to the spring accumulator and releases the brakes of the vehicle 300.

To provide the parking brake function, the brake system 200 includes the electropneumatic parking brake device 1. This includes an electropneumatic parking brake valve unit 2, which is supplied with reservoir pressure pV via a reservoir connection 4. In the embodiment shown, the reservoir connection 4 is connected to the first compressed air reservoir 206. In this case, the parking brake valve unit 2 is also supplied with reservoir pressure pV by the second compressed air reservoir 210. In other variants, the electropneumatic parking brake valve unit 2 can alternatively or additionally be connected to a third compressed air reservoir, which is preferably independent of the first compressed air reservoir 206 and the second compressed air reservoir 210. It should be understood that the electropneumatic parking brake valve unit 2 can be supplied only from the first compressed air reservoir 206, only from the second compressed air reservoir 210, only from the third compressed air reservoir 206, from at least two compressed air reservoirs or from the first compressed air reservoir 206, from the second compressed air reservoir 210 and from the third compressed air reservoir.

The electropneumatic parking brake valve unit 2 includes a parking brake control unit 6 that is connected via the vehicle BUS 216 to the autonomous driving unit 218. To apply the parking brake, the autonomous driving unit 218 provides a parking brake signal SFS to the parking brake control unit 6 via the vehicle BUS 216, and the parking brake control unit thereupon provides the parking pressure pFS at a first spring accumulator connection 8a and at a second spring accumulator connection 8b. In FIG. 1, the first spring accumulator connection 8a is connected to the spring brake cylinders 254d, 254f, and the second spring accumulator connection 8b is connected to the spring brake cylinders 254c, 254e. By providing the parking pressure pFS, the electropneumatic parking brake valve unit 2 pressurizes the spring brake cylinders 254c-254f and thus releases the parking brake. To apply the parking brake of the vehicle 300, the electropneumatic parking brake valve unit 2 can vent the spring accumulator connections 8a, 8b and the spring brake cylinders 254c-254f connected thereto. This may be performed in response to corresponding second parking brake signals being received at the parking brake control unit 6, or when parking brake signals SFS are no longer being provided by the parking brake control unit 6.

To provide redundancy for the electropneumatic parking brake valve unit 2, the electropneumatic parking brake device 1 further includes an electropneumatic parking brake redundancy unit 10. The parking brake redundancy unit 10 is configured to vent at least one of the spring brake cylinders 254c-254f independently of the electropneumatic parking brake valve unit 2. This may be implemented directly or indirectly. Thus, as shown in the embodiment according to FIG. 1, the parking brake redundancy unit 10 can vent a parking compressed air path 12, which is directly connected to the spring brake cylinders 254c-254f, directly into the environment. However, in alternative variants, the parking compressed air path 12 can also be connected to the first compressed air reservoir 206 and/or the second compressed air reservoir 210. Furthermore, the parking compressed air path 12 can alternatively or additionally also be connected to a third compressed air reservoir, which is not shown in FIG. 1. The parking brake redundancy unit 10 then connects this parking compressed air path 12 connected to the first compressed air reservoir 206, the second compressed air reservoir 210 or a third compressed air reservoir to the environment in order to bring about venting of the spring brake cylinders 254c-254f. The connection to the environment is via one or more redundancy vents 14, 15 of the electropneumatic parking brake redundancy unit 10. The parking brake redundancy unit 10 can thus be used to vent just one compressed air reservoir 206, 210 or to vent two, three, four or more compressed air reservoirs 206, 210.

The parking brake redundancy unit 10 includes a main connection 16, which is provided for connecting to the parking compressed air path 12. In FIG. 1, the spring brake cylinders 254c-254f are connected directly to the main connection 16 and the spring accumulator connections 8a, 8b. In the embodiment shown in FIG. 1, the parking brake redundancy unit 10 thus receives the parking pressure pFS at the main connection 16 if the parking brake of the vehicle 300 is released or the spring brake cylinders 254c-254f are pressurized.

The electropneumatic parking brake redundancy unit 10 is configured to connect the main connection 16 to a redundancy vent 14, 15. For this purpose, the electropneumatic parking redundancy unit 10 includes a first venting path 18 and a second venting path 30. The first venting path 18 and the second venting path 30 are at least partially parallel venting paths 18, 30 of the electropneumatic parking brake redundancy unit 10. In the embodiment according to FIG. 1, the first venting path 18 extends from the main connection 16 via a first electropneumatic redundancy valve unit 22 to a first redundancy vent 14 and flows into the environment there. The second venting path 30 of the electropneumatic parking brake redundancy unit 10 runs parallel to the first venting path 18 from the main connection 16 to a second redundancy vent 15 and flows into the environment there. In other variants, however, the electropneumatic parking brake redundancy unit 10 could, for example, have two main connections 16. In some variants, the first venting path 16 and the second venting path 30 can also have a common redundancy vent 14, 15.

Here, the parking compressed air path 12 connects the spring accumulator connections 8a, 8b of the electropneumatic parking brake valve unit 2 to the spring brake cylinders 254c, 254d, 254e, 254f. If the electropneumatic parking brake valve unit 2 has a fault and the spring accumulator pressure pFS present in the parking compressed air path 12 can no longer vent in order to apply the parking brake, the electropneumatic parking brake redundancy unit 10 forms a redundancy. The parking pressure pFS present in the parking compressed air path 12 for pressurizing the spring brake cylinders 254c, 254d, 254e, 254f is also applied to the main connection 16 of the electropneumatic parking brake redundancy unit 10 and can be vented via the first venting path 18, the second venting path 30 or both the first venting path 18 and the second venting path 30 into the environment in order to apply the parking brake of the vehicle 300. Thus, even if venting via the electropneumatic parking brake valve unit 2 is no longer possible on account of a fault, the parking brake cylinders 254c-254f can be connected to the environment via the first venting path 18 or via the second venting path 30 and thus vented.

FIG. 1 shows schematically the arrangement of the first electropneumatic redundancy valve unit 22 in the first venting path 18 and the second electropneumatic redundancy valve unit 24 in the second venting path 30. However, it should be understood that subcomponents of the first electropneumatic redundancy valve unit 22 may also be arranged in the second venting path 30 and/or that subcomponents of the second electropneumatic redundancy valve unit 24 may also be arranged in the first venting path 18. The first redundancy valve unit 22 can be controlled by a first control unit 26, which is the primary control unit 214 in the embodiment shown. For this purpose, the first redundancy valve unit 22 is connected to the primary control unit 214 via a first redundancy signal line 256. The second redundancy valve unit 24 can be controlled in an analogous manner by a second control unit 28, which is formed here by the secondary control unit 242. The connection between the secondary control unit 242 and the second redundancy valve unit 24 is made via a second redundancy signal line 258. The primary control unit 214 and the secondary control unit 242 are independent of one another and are supplied by separate voltage sources 222, 246, and it is therefore a particularly simple matter to create a redundancy level with a high degree of fail safety by using the primary control unit 214 as the first control unit 26 and the secondary control unit 242 as the second control unit 28.

In the embodiment shown in FIG. 1, both the first control unit 26 and the second control unit 28 are independent of the parking brake control unit 6. In other embodiments, however, it is also possible, for example, for the parking brake control unit 6 to form or include the first control unit 26 or the second control unit 28.

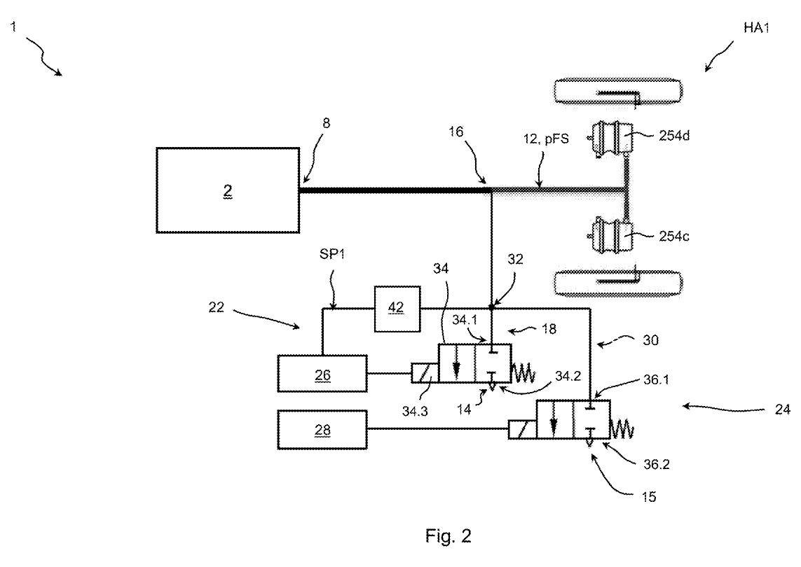

FIG. 2 then shows schematically a first embodiment of the electropneumatic parking brake device 1, wherein, for the sake of simplicity, the first rear axle HA1 with the associated parking brake cylinders 254c, 254d is furthermore also shown. The electropneumatic parking brake valve unit 2 is shown schematically, wherein the spring accumulator connections 8a, 8b are shown here in simplified form as a common spring accumulator connection 8. The main connection 16 is likewise shown only in a very simplified manner and opens into the parking compressed air path 12, which in this case is a connecting line between the spring accumulator connection 8 of the parking brake valve unit 2 and the spring brake cylinders 254c, 254d.

In the first embodiment, the first venting path 18 and also the second venting path 30 of the electropneumatic parking brake redundancy unit 10 are connected to the main connection 16. Downstream of the main connection 16, the venting paths 18, 20 branch at a schematically illustrated node 32.

The first venting path 18 runs from the node 32 to a first electrically switchable venting valve 34 of the first electropneumatic redundancy valve unit 22. In the embodiment shown in FIG. 2, the first electrically switchable venting valve 34 is an electrically switchable 2/2-way valve. An inlet connection 34.1 of the first electrically switchable venting valve 34 is connected directly to the node 32 and the main connection 16 arranged upstream of the node 32. A first outlet connection 34.2 of the first electrically switchable venting valve 34 is connected directly to the first redundancy vent 14. In some variants, however, a further line may also be provided between the first outlet connection 34.2 and the first redundancy vent 14.

In the first embodiment, the first electrically switchable venting valve 34 is configured as a solenoid valve. The first control unit 26 is adapted for controlling the first electrically switchable venting valve 34 of the first electropneumatic redundancy valve unit 22. Here, the control unit 26 can energize a first solenoid 34.3 of the first electrically switchable venting valve 34 in order to switch the first electrically switchable venting valve 34 from a closed switching position shown in FIG. 2 to an open switching position. In the open switching position, the first inlet connection 34.1 and the first outlet connection 34.2 of the first electrically switchable venting valve 34 are fluidically connected conductively, so that the first electrically switchable venting valve 34 releases the first venting path 18 in the open switching position. The parking pressure pFS of the parking compressed air path 12 applied to the main connection 16 can then be vented directly into the environment via the first venting path 18 and the first redundancy vent 14. As a result, the spring brake cylinders 254c, 254d are also vented via the parking compressed air path 12 and the parking brake is applied.

In the closed switching position, the first electrically switchable venting valve 34 interrupts the connection of the first inlet connection 34.1 to the first outlet connection 34.2. In the first embodiment and by way of preference, the first electrically switchable venting valve 34 is monostable and preloaded into the closed position. When the first control unit 26 no longer actuates the first electrically switchable venting valve 34 or, in the present case, no longer supplies the first solenoid 34.3 with electrical energy, the first electrically switchable venting valve 34 automatically returns to the closed switching position. This prevents the first venting path 18 from being opened in the event of a fault in the first control unit 26.

In an analogous manner, the second venting path 30 includes a second electrically switchable venting valve 36. In the present case, this second electrically switchable venting valve 36 is essentially identical to the first electrically switchable venting valve 34. The second venting path 30 extends from the main connection 16 via the node 32, a second inlet connection 36.1 of the first electrically switchable venting valve 36 to a second outlet connection 36.2 of the electrically switchable venting valve 36 and the second redundancy vent 15 directly connected thereto. Here too, however, it would be possible to provide another line between the second outlet connection 36.2 and the second redundancy vent 15. Furthermore, the second outlet connection 36.2 could also be connected to the first redundancy vent 14.

The second control unit 28 is configured to switch the second electrically switchable venting valve 36 from a closed switching position to an open switching position and thus to open the second venting path 30. The parking pressure pFS can then flow along the second venting path 30 from the main connection 16 to the second redundancy vent 15, thereby venting the parking compressed air path 12 and the spring brake cylinders 254c, 254d. The second electrically switchable venting valve 36 is also preloaded into a closed state, such that, in the event of a fault of the second control unit 28, it interrupts the second venting path 30.

The first control unit 26 and the second control unit 28 can simultaneously open the first venting path 18 and the second venting path 30 to achieve a particularly high volume flow through the electropneumatic parking redundancy unit 10 and to rapidly vent the parking compressed air path 12. In order to vent at least one spring brake cylinder 254c, 254d, however, it is also always possible to open just one of the venting paths 18, 30, for example.

In the first embodiment according to FIG. 2, the parking brake redundancy unit 10 further includes a first pressure sensor 42, which is here configured for detecting a pressure of the first venting path 18 and second venting path 30. The first pressure sensor 42 is connected to the first control unit 26 and provides first pressure signals SP1 corresponding to the detected pressure at the first control unit 26. In other variants of the parking brake device 1, it is also possible, however, for the first pressure sensor 42 to be connected to the second control unit 28. It is furthermore also possible for two or more pressure sensors 42 to be provided. In the first embodiment, the first pressure sensor 42 is arranged upstream of the first electrically switchable venting valve 34. Specifically, the first pressure sensor 42 is provided here for detecting a pressure level prevailing at the node 32. Thus, the first control unit 26 can use the pressure signals provided by the first pressure sensor 42 to determine whether the parking pressure pFS is present at the parking compressed air path 12 or whether the spring brake cylinders 254c, 254d are pressurized or vented.

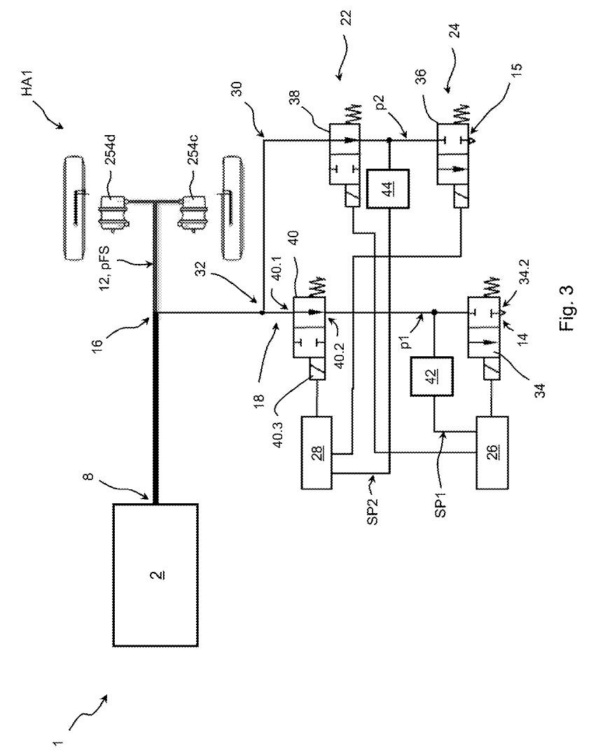

FIG. 3 illustrates a second embodiment of the electropneumatic parking brake device 1, wherein the illustration is substantially analogous to the first embodiment. Once again, the first venting path 18 and the second venting path 30 are connected from the main connection 16 to the node 32 and divide downstream of the node 32 into two parallel venting paths 18, 30.

In the second embodiment, the first electrically switchable venting valve 34 is of analogous configuration to the first embodiment. Thus, in the second embodiment too, the first electrically switchable venting valve 34 is a 2/2-way solenoid valve, which is preloaded into a closed state and is controlled by the first control unit 26. In the embodiment according to FIG. 3 too, the first outlet connection 34.2 ends in the first redundancy vent 14. Here, in the first venting path 18, however, in addition to the first electrically switchable venting valve 34, a fourth venting valve 40 is also provided. The fourth venting valve 40 can be controlled by the second control unit 28 and is part of the second redundancy valve unit 24. The fourth electrically switchable venting valve 40 is arranged upstream of the first electrically switchable venting valve 34 in the first venting path 18.

In the second embodiment, the fourth electrically switchable venting valve 40 is likewise a 2/2-way valve and includes a fourth inlet connection 40.1 and a fourth outlet connection 40.2. The second control unit 28 can provide electrical energy to a fourth solenoid 40.3 of the fourth electrically switchable venting valve 40 in order to switch the fourth electrically switchable venting valve 40 between an open position, in which the fourth inlet connection 40.1 and the fourth outlet connection 40.2 are fluidically connected, and a closed position, in which the fourth electrically switchable venting valve 40 interrupts the first venting path 18. The electrically switchable venting valve 40 is also monostable. In contrast to the first electrically switchable venting valve 34, however, it is preloaded to the open position and not to the closed position. In the event of a fault of the second control unit 28, the fourth electrically switchable venting valve 40 therefore opens the first venting path 18.

In an analogous manner, the second venting path 30 includes a third electrically switchable venting valve 38, which can be controlled by the first control unit 26. The third electrically switchable venting valve 38 is arranged in the second venting path 30 upstream of the second electrically switchable venting valve 36. Analogously to the fourth electrically switchable venting valve 40, the third electrically switchable venting valve 38 too can be switched by energization to a closed switching position and can thus interrupt the second venting path 30.

In the second embodiment, which is shown in FIG. 3, the electropneumatic parking brake device 1 includes, in addition to the first pressure sensor 42, a second pressure sensor 44. The second pressure sensor 44 provides second pressure signals SP2 for the second control unit 28. Here, the first pressure sensor 42 is configured to detect a first pressure p1 of the first venting path 18. Specifically, the first pressure sensor 42 in this case detects the first pressure p1 between the fourth electrically switchable venting valve 40 and the first electrically switchable venting valve 34. Analogously, the second pressure sensor 44 is configured to detect a second pressure p2 of the second venting path 30 between the third electrically switchable venting valve 38 and the second electrically switchable venting valve 36.

Using the first pressure signals SP1, the first control unit 26 can determine, for example, whether the first parking compressed air path 12 is subject to parking pressure pFS and/or whether the fourth electrically switchable venting valve 40 is open or not.

In the second embodiment of the electropneumatic parking brake device 1 too, the parking compressed air path 12 can be connected via the first venting path 18 and/or the second venting path 30 to a redundancy vent 14, 15 and thus be vented into the environment. For example, the first control unit 26 can supply the first electrically switchable venting valve 34 with electrical energy and thus switch to the open position. If the second control unit 28 is fully functional, it does not supply electrical energy to the fourth solenoid 40.3 of the fourth electrically switchable venting valve 40 and thus leaves the fourth electrically switchable venting valve 40 in the open position, in which it opens the first venting path 18. Even in the event of a total failure of the second control unit 28, the first control unit 26 can bring about venting of the parking compressed air path 12 since in this case the second control unit does not supply the fourth electrically switchable venting valve 40 with electrical energy and thus also cannot switch to the closed switching position.

The fourth electrically switchable holding valve 40 additionally provided in comparison with the first embodiment also permits additional redundancy in the event that the first control unit 26 has a fault which causes the first control unit 26 to open the first electrically switchable venting valve 34, even though the parking brake of the vehicle 300 should not be applied in a current (driving) situation. In the event of such a fault of the first control unit 26, the second control unit 28 can close the fourth electrically switchable venting valve 40 (energize the solenoid 40.3) and thus interrupt the first venting path 18. Analog functionality is obtained for the third electrically switchable venting valve 38 arranged in the second venting path 30.

According to various embodiments, the first electrically switchable venting valve 34, the second electrically switchable venting valve 36, the third electrically switchable venting valve 38 and the fourth electrically switchable venting valve 40 are arranged in a common housing (not shown in the FIGS.).

It is understood that the foregoing description is that of the preferred embodiments of the invention and that various changes and modifications may be made thereto without departing from the spirit and scope of the invention as defined in the appended claims.

### REFERENCE SIGNS PART OF THE DESCRIPTION

1 Parking brake device
2 Parking brake valve unit
4 Reservoir connection
6 Parking brake control unit
8, 8a, 8b, Spring accumulator connections
10 Parking brake redundancy unit
12 Parking compressed air path
14 First redundancy vent
15 Second redundancy vent
16 Main connection
18 First venting path
22 First redundancy valve unit
24 Second redundancy valve unit
26 First control unit
28 Second control unit
30 Second venting path
32 Node
34 First electrically switchable venting valve
34.1 First inlet connection
34.2 First outlet connection
34.3 First solenoid
36 Second electrically switchable venting valve
36.1 Second inlet connection
36.2 Second outlet connection
38 Third electrically switchable venting valve
40 Fourth electrically switchable venting valve
40.1 Fourth inlet connection
40.2 Fourth outlet connection
40.3 Fourth solenoid
42 First pressure sensor
44 Second pressure sensor
200 Electronically controllable pneumatic brake system
202 Rear axle brake circuit
204 Front axle brake circuit
206 First compressed air reservoir
207 Trailer brake circuit
208a-208f Service brake actuators
208a, 208b Front axle brake actuators
208c, 208d, Rear axle brake actuators
208e, 208f
209 Trailer module
210 Second compressed air reservoir
212 Primary system
214 Primary control unit
216 Vehicle BUS
218 Autonomous driving unit
220 First supply line
222 First voltage source
224 First service axle modulator
228 Front axle modulator
230 Reservoir connection
232.1 First service brake pressure connection
232.2 Second service brake pressure connection
234 Wheel speed sensor
236 Second service axle modulator
237 Rear axle modulator
238 ABS valves
240 Central module
241 Secondary system
242 Secondary control unit
244 Second supply line
246 Second voltage source
248 Redundancy BUS
250 Redundancy axle modulator
252 Redundancy brake pressure connection
254c-254f Spring brake cylinder
256 First redundancy signal line
258 Second redundancy signal line
260 Select-high valve
262 Push-pull valve
264 Foot brake pedal
300 Vehicle
302 Commercial vehicle
HA1 First rear axle
HA2 Second rear axle
p1 First pressure
p2 Second pressure
pB1 First service brake pressure
pB2 Second service brake pressure
pB3 Third service brake pressure
pBR1 Redundancy brake pressure
pFS Parking pressure
SA Braking demand signals
SB Service brake signals
SD Wheel speed signals
SFS Parking brake signal
SP1 First pressure signals
SP2 Second pressure signals
VA Front axle

1. An electropneumatic parking brake device for pressurizing and venting at least one spring brake cylinder of an at least partially electronically controllable pneumatic brake system for a vehicle, the electropneumatic parking brake device comprising:
an electropneumatic parking brake valve unit having a reservoir connection for receiving reservoir pressure from a compressed air reservoir and a parking brake control unit;
said electropneumatic parking brake valve unit being configured to output a parking pressure at least at one spring accumulator connection in accordance with a parking brake signal;
an electropneumatic parking brake redundancy unit configured to connect a parking compressed air path to a vent independently of said electropneumatic parking brake valve unit in order to vent the at least one spring brake cylinder;
said electropneumatic parking brake redundancy unit including at least one first main connection for receiving a pressure of the parking compressed air path, a first venting path for venting the pressure directly into an environment, and a second venting path for venting the pressure directly into the environment;
said electropneumatic parking brake redundancy unit including a first electropneumatic redundancy valve unit arranged in said first venting path and configured to be controlled by a first control unit;
said electropneumatic parking brake redundancy unit further including a second electropneumatic redundancy valve unit arranged in said second venting path and configured to be controlled by a second control unit;
said second control unit being independent of said first control unit; and,
said first venting path and said second venting path being mutually parallel venting paths for venting the received pressure of the parking compressed air path directly into the environment.

2. The electropneumatic parking brake device of claim 1, wherein:
said first electropneumatic redundancy valve unit has a first electrically switchable venting valve arranged in said first venting path;
said first electrically switchable venting valve is configured to interrupt said first venting path in a de-energized state; and,
said second electropneumatic redundancy valve unit has a second electrically switchable venting valve arranged in said second venting path; and,
said second electrically switchable venting valve being configured to interrupt said second venting path in a de-energized state.

3. The electropneumatic parking brake device of claim 2, wherein:
said first electropneumatic redundancy valve unit has a third electrically switchable venting valve arranged in said second venting path; and,
said second electropneumatic redundancy valve unit has a fourth electrically switchable venting valve arranged in said first venting path.

4. The electropneumatic parking brake device of claim 3, wherein said third electrically switchable venting valve is open in a de-energized state; and, said fourth electrically switchable venting valve is open in a de-energized state.

5. The electropneumatic parking brake device of claim 2 further comprising:
a first pressure sensor for detecting a first pressure of said first venting path;
said first pressure sensor being configured to provide said first control unit with first pressure signals corresponding to the detected first pressure;
a second pressure sensor for detecting a second pressure of said second venting path; and,
said second pressure sensor being configured to provide said second control unit with second pressure signals corresponding to the detected second pressure.

6. The electropneumatic parking brake device of claim 5, wherein said first pressure sensor is arranged upstream of said first electrically switchable venting valve; and, said second pressure sensor is arranged upstream of said second electrically switchable venting valve.

7. The electropneumatic parking brake device of claim 1, wherein said first electrically switchable venting valve and said second electrically switchable venting valve are 2/2-way valves.

8. An electronically controllable pneumatic brake system for a vehicle, the electronically controllable pneumatic brake system comprising:
a first front axle brake actuator and a second front axle brake actuator and a first rear axle brake actuator and a second rear axle brake actuator;
a spring brake cylinder;
a primary system including a primary control unit for at least one of controlling said first front axle brake actuator and said second front axle brake actuator and controlling said first rear axle brake actuator and said second rear axle brake actuator;
an electropneumatic parking brake device for pressurizing and venting said spring brake cylinder;
said electropneumatic parking brake device including an electropneumatic parking brake valve unit having a reservoir connection for receiving reservoir pressure from a compressed air reservoir and a parking brake control unit;
said electropneumatic parking brake valve unit being configured to output a parking pressure at least at one spring accumulator connection in accordance with a parking brake signal;
said electropneumatic parking brake device including an electropneumatic parking brake redundancy unit configured to connect a parking compressed air path to a vent independently of said electropneumatic parking brake valve unit in order to vent said spring brake cylinder;
said electropneumatic parking brake redundancy unit including at least one first main connection for receiving a pressure of the parking compressed air path, a first venting path for venting the pressure directly into an environment, and a second venting path for venting the pressure directly into the environment;
said electropneumatic parking brake redundancy unit including a first electropneumatic redundancy valve unit arranged in said first venting path and configured to be controlled by a first control unit;
said electropneumatic parking brake redundancy unit further including a second electropneumatic redundancy valve unit arranged in said second venting path and configured to be controlled by a second control unit;
said second control unit being independent of said first control unit; and,
said first venting path and said second venting path being mutually parallel venting paths for venting the received pressure of the parking compressed air path directly into the environment; and,
said spring brake cylinder being at least one spring brake cylinder including at least one first spring brake cylinder connected to said at least one spring accumulator connection of said electropneumatic parking brake valve unit.

9. The electronically controllable pneumatic brake system of claim 8, wherein said at least one first spring brake cylinder is connected to said at least one first main connection of said electropneumatic parking brake redundancy unit; said electropneumatic parking brake redundancy unit is switchable in order to connect said at least one spring brake cylinder to the environment via said first venting path, via said second venting path, or via said first venting path and said second venting path in order to vent said at least one spring brake cylinder.

10. The electronically controllable pneumatic brake system of claim 8, wherein said at least one first main connection is connected to a first compressed air reservoir of the electronically controllable pneumatic brake system; said electropneumatic parking brake redundancy unit is switchable in order to connect at least said first compressed air reservoir to the environment via said first venting path, via said second venting path, or via said first venting path and said second venting path in order to vent said first compressed air reservoir.

11. The electronically controllable pneumatic brake system of claim 8, wherein said primary control unit is or includes said first control unit.

12. The electronically controllable pneumatic brake system of claim 8 further comprising:
a secondary system having a secondary control unit;
said secondary system being configured to at least one of control said first front axle brake actuator and said second front axle brake actuator and control said first rear axle brake actuator and said second rear axle brake actuator if a fault is detected in said primary system.

13. The electronically controllable pneumatic brake system of claim 12, wherein said secondary control unit is or includes said second control unit.

14. The electronically controllable pneumatic brake system of claim 8 further comprising:
a first voltage source for supplying said first control unit with electrical voltage; and,
a second voltage source for supplying said second control unit with electrical voltage.

15. A vehicle comprising:
at least one front axle;
at least one first rear axle;
an electronically controllable pneumatic brake system including a spring brake cylinder, a first front axle brake actuator and a second front axle brake actuator and a first rear axle brake actuator and a second rear axle brake actuator;
said electronically controllable pneumatic brake system further including a primary system including a primary control unit for at least one of controlling said first front axle brake actuator and said second front axle brake actuator and controlling said first rear axle brake actuator and said second rear axle brake actuator;
said electronically controllable pneumatic brake system further including an electropneumatic parking brake device for pressurizing and venting said spring brake cylinder;
said electropneumatic parking brake device including an electropneumatic parking brake valve unit having a reservoir connection for receiving reservoir pressure from a compressed air reservoir and a parking brake control unit;
said electropneumatic parking brake valve unit being configured to output a parking pressure at least at one spring accumulator connection in accordance with a parking brake signal;
said electropneumatic parking brake device including an electropneumatic parking brake redundancy unit configured to connect a parking compressed air path to a vent independently of said electropneumatic parking brake valve unit in order to vent said spring brake cylinder;
said electropneumatic parking brake redundancy unit including at least one first main connection for receiving a pressure of the parking compressed air path, a first venting path for venting the pressure directly into an environment, and a second venting path for venting the pressure directly into the environment;
said electropneumatic parking brake redundancy unit including a first electropneumatic redundancy valve unit arranged in said first venting path and configured to be controlled by a first control unit;
said electropneumatic parking brake redundancy unit further including a second electropneumatic redundancy valve unit arranged in said second venting path and configured to be controlled by a second control unit;
said second control unit being independent of said first control unit; and,
said first venting path and said second venting path being mutually parallel venting paths for venting the received pressure of the parking compressed air path directly into the environment; and,
said spring brake cylinder being at least one spring brake cylinder including at least one first spring brake cylinder connected to said at least one spring accumulator connection of said electropneumatic parking brake valve unit.

16. The vehicle of claim 15, wherein the vehicle is a commercial vehicle.
